(19) United States
(12) Patent Application Publication
(10) Pub. No.: US 2025/0223033 A1
(43) Pub. Date: Jul. 10, 2025

(54) CONTROL DEVICE

(71) Applicant: TOYOTA JIDOSHA KABUSHIKI KAISHA, Toyota-shi (JP)

(72) Inventor: Taro TSUKADA, Shizuoka-ken (JP)

(73) Assignee: TOYOTA JIDOSHA KABUSHIKI KAISHA, Toyota-shi (JP)

(21) Appl. No.: 18/936,237

(22) Filed: Nov. 4, 2024

(30) Foreign Application Priority Data
Jan. 9, 2024 (JP) 2024-001322

(51) Int. Cl. B64C 31/06; H04N 23/11

(52) U.S. Cl. CPC B64C 31/06; H04N 23/11

(57) ABSTRACT

The disclosure relates to a control device. The control device includes an acquisition unit configured to acquire an infrared image including at least part of surroundings of the moving object, and an estimation unit configured to estimate an imaginary horizontal axis based on an atmospheric temperature distribution shown by the infrared image.

### CROSS-REFERENCE TO RELATED APPLICATION

This application claims priority to Japanese Patent Application No. 2024-001322 filed on Jan. 9, 2024, incorporated herein by reference in its entirety.

### BACKGROUND

### 1. Technical Field

The present disclosure relates to a technical field of control devices for moving objects.

### 2. Description of Related Art

For example, a device of this type has been proposed that calculates the position of the horizon in an image captured by an infrared camera from an altitude signal from an altitude detection unit of an aircraft and an angle signal from a visual axis orientation angle detection unit of the aircraft, and performs luminance conversion so that the contrast in a region centered on the calculated horizon is enhanced (Japanese Unexamined Patent Application Publication No. 9-130680 (JP 9-130680 A)).

### SUMMARY

There is room for improvement in the technique described in JP 9-130680 A.

The present disclosure was made in view of the above circumstances, and an object of the present disclosure is to provide a control device that can estimate a horizontal axis.

A control device according to an aspect of the present disclosure includes: an acquisition unit that acquires an infrared image including at least part of surroundings of a moving object; and an estimation unit that estimates an imaginary horizontal axis based on an atmospheric temperature distribution shown by the infrared image.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a kite;

FIG. 2 is a block diagram illustrating an example of a configuration of a control device according to the embodiment;

FIG. 3 is a block diagram illustrating an example of a configuration of an arithmetic device according to the embodiment;

FIG. 4 is a schematic diagram schematically showing an infrared image; and

FIG. 5 is a block diagram illustrating another example of a configuration of an arithmetic device according to the embodiment.

### DETAILED DESCRIPTION OF EMBODIMENTS

### First Embodiment

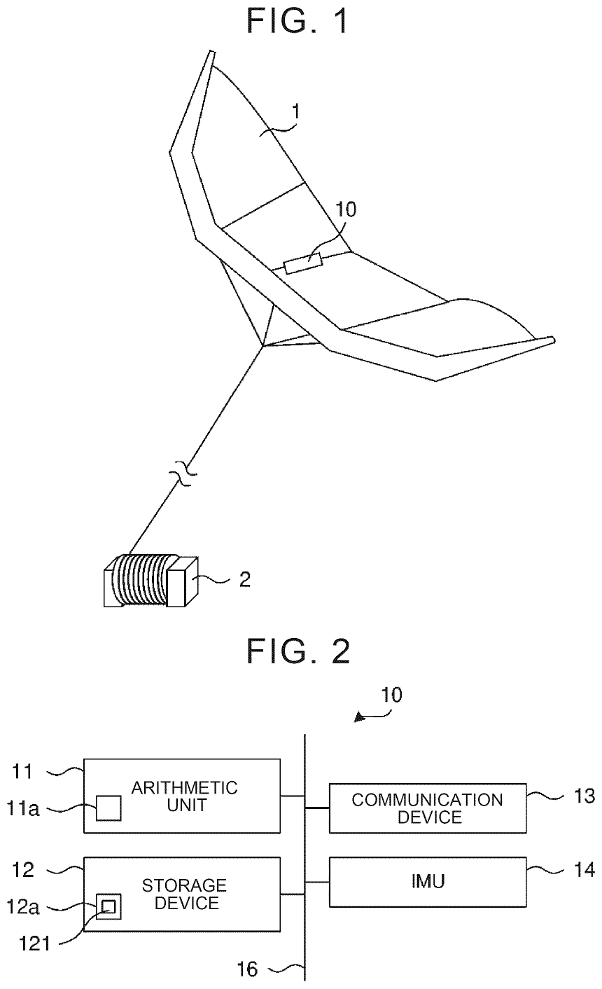

A first embodiment of the control device will be described with reference to FIGS. 1 to 4. In the embodiment, a kite is mentioned as an example of a moving object. However, the moving object is not limited to a kite. The moving object may include a moving object moving in the air (in other words, a flying object) and a moving object moving on the ground. The moving object may be an unmanned moving object or a manned moving object. The moving object may be an autonomously movable moving object.

In FIG. 1, the kite 1 is moored by a tether (kite yarn) to equipment 2 having a drum around which the tether is wound. Note that the equipment 2 may be installed on the ground, may be installed on a structure, or may be installed on a device capable of transporting the drum such as a vehicle or a ship. The kite 1 may be, for example, an inflatable kite. However, the kite 1 is not limited to inflatable kite.

A control device 10 is attached to the kite 1. Note that the control device 10 may not be attached to the kite 1. For example, the equipment 2 may comprise a control device 10. The control device 10 will be described with reference to FIG. 2. In FIG. 2, the control device 10 includes an arithmetic unit 11, a storage device 12, a communication device 13, and an IMU (Inertial Measurement Unit) 14. The arithmetic unit 11, the storage device 12, the communication device 13, and IMU 14 may be connected via a data bus 16. Note that the control device 10 may include at least one of an inputting device and an outputting device in addition to the arithmetic unit 11, the storage device 12, the communication device 13, and IMU 14.

The arithmetic unit 11 may include a processor 11a. Note that the arithmetic unit 11 may include other processors in addition to the processor 11a. That is, the arithmetic unit 11 may include one or more processors. Note that the processor 11a may be a multi-core processor. When the arithmetic unit 11 includes a single processor 11a that is a multi-core processor, it can be said that the arithmetic unit 11 logically includes a plurality of processors.

The processor 11a may be at least one of, for example, CPU (Central Processing Unit), GPU (Graphics Processing Unit), FPGA (Field Programmable Gate Array), and TPU (Tensor Processing Unit).

The storage device 12 may include a memory 12a. Note that the storage device 12 may include other memories in addition to the memory 12a. That is, the storage device 12 may have one or more memories. The memory 12a may be, for example, at least one of a RAM (Random Access Memory), a ROM (Read Only Memory), a hard disk drive, a magneto-optical disk drive, an SSD (Solid State Drive), and an optical disk array. Therefore, the storage device 12 may have a memory 12a as a non-transitory recording medium.

The communication device 13 may be capable of communicating with a device external to the control device 10. The communication device 13 may perform wired communication or wireless communication. As for IMU 14, various conventional aspects can be applied, and thus detailed explanation thereof will be omitted.

The storage device 12 can store desired data. A computer program 121 executed by the arithmetic unit 11 may be stored in the memory 12a of the storage device 12. The storage device 12 may temporarily store data temporarily used by the arithmetic unit 11 when the arithmetic unit 11 is executing the computer program 121. Note that the computer program 121 may be acquired from a device (not shown) outside the control device 10 via the communication device 13 (in other words, may be downloaded). The obtained computer program 121 may be stored in a memory 12a.

The processor 11a of the arithmetic unit 11 may execute a process to be performed by the control device 10 together with the memory 12a of the storage device 12 in which the computer program 121 is stored. In other words, the process to be performed by the control device 10 may be executed together with the memory 12a and the computer program 121 stored in the memory 12a. For example, the processor 11a may execute the computer program 121 to implement a logical functional block for executing a process to be performed by the control device 10 in the arithmetic unit 11.

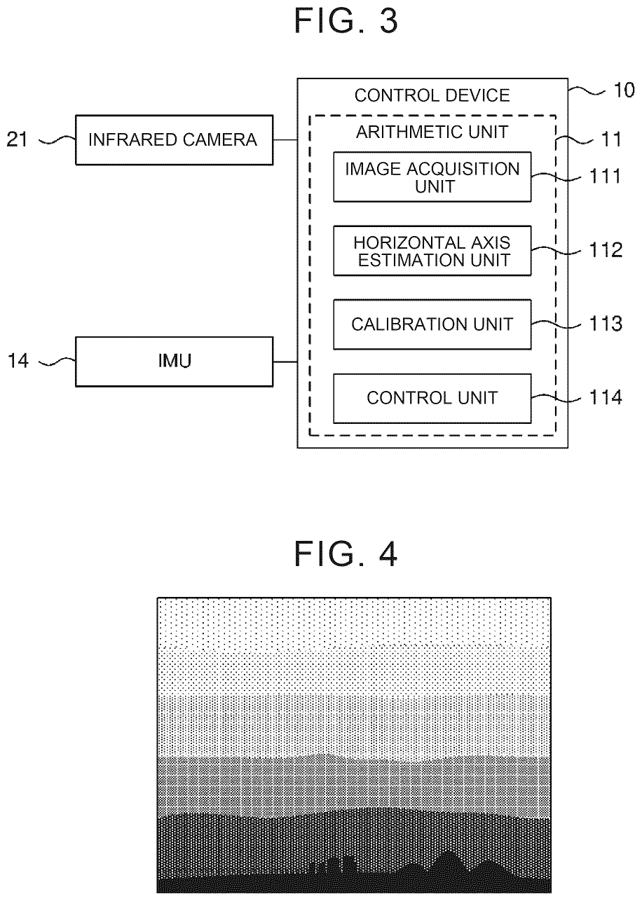

The control device 10 will be described with reference to FIG. 3. In FIG. 3, the arithmetic unit 11 of the control device 10 includes an image acquisition unit 111, a horizontal axis estimation unit 112, a calibration unit 113, and a control unit 114 as functional blocks that are logically realized or as processing circuits that are physically realized. Note that at least one of the image acquisition unit 111, the horizontal axis estimation unit 112, the calibration unit 113, and the control unit 114 may be realized in a format in which a logical functional block and a physical processing circuit (that is, hardware) are mixed.

When the image acquisition unit 111, the horizontal axis estimation unit 112, the calibration unit 113, and the control unit 114 are implemented as functional blocks, the image acquisition unit 111, the horizontal axis estimation unit 112, the calibration unit 113, and the control unit 114 may be implemented by a single processor (for example, a processor 11a). Alternatively, the image acquisition unit 111, the horizontal axis estimation unit 112, the calibration unit 113, and the control unit 114 may be realized by different processors. Alternatively, part of the image acquisition unit 111, the horizontal axis estimation unit 112, the calibration unit 113, and the control unit 114 may be realized by one processor. Further, the remaining portions of the image acquisition unit 111, the horizontal axis estimation unit 112, the calibration unit 113, and the control unit 114 may be realized by one or more processors different from one processor.

An infrared camera 21 may be attached to the kite 1. The infrared camera 21 may generate an infrared image by capturing at least part of the surroundings of the kite 1. The image acquisition unit 111 of the arithmetic unit 11 acquires an infrared image (that is, an infrared image including at least part of the surroundings of the kite 1) from the infrared camera 21.

The higher the temperature of the object, the greater the amount of infrared radiation emitted from the object. Therefore, the infrared image generated by the infrared camera 21 capturing at least part of the surroundings of the kite 1 can be said to be an image showing the temperature distribution of the object. An example of an infrared image will now be described with reference to FIG. 4. The temperature of the atmosphere varies along the vertical direction. Therefore, the atmosphere belonging to a certain temperature range forms a layer extending in a direction intersecting the vertical direction. As shown in FIG. 4, in the infrared image, when one temperature zone and another temperature zone adjacent to the one temperature zone are represented by different colors, the boundary between the one temperature zone and the other temperature zone extends in a direction intersecting the vertical direction.

The horizontal axis estimation unit 112 of the arithmetic unit 11 estimates the imaginary horizontal axis based on the atmospheric temperature distribution shown by the infrared image. For example, the horizontal axis estimation unit 112 may estimate the imaginary horizontal axis by obtaining an approximate straight line corresponding to the boundary between one temperature zone and another temperature zone described above.

The calibration unit 113 may calibrate the attitude of the kite 1 measured by IMU 14 based on the imaginary horizontal axis estimated by the horizontal axis estimation unit 112. The control unit 114 may control the kite 1 based on the attitude of the kite 1 calibrated by the calibration unit 113.

### Technical Effect

The horizontal axis may be used, for example, to identify the attitude of the moving object. As the horizontal axis, for example, at least one of a horizontal line and a boundary between the ground and the sky may be used. However, it is limited if the horizontal line can be used as the horizontal axis. Further, the boundary between the ground and the sky is not necessarily horizontal due to, for example, a terrain or a structure. On the other hand, in the control device 10, the horizontal axis estimation unit 112 estimates the imaginary horizontal axis based on the atmospheric temperature distribution shown by the infrared image. As described above, the temperature of the atmosphere varies along the vertical direction, and the atmosphere belonging to a certain temperature zone forms a layer extending in a direction intersecting the vertical direction. Therefore, the control device 10 can appropriately estimate the imaginary horizontal axis by using the atmospheric temperature distribution. In addition, the control device 10 can appropriately estimate the imaginary horizontal axis regardless of day and night by using the infrared image. The method of estimating the imaginary horizontal axis based on the atmospheric temperature distribution is applicable not only to the Earth but also to planets where the atmosphere exists.

Like the kite 1 shown in FIG. 1, the kite 1 anchored by the tether has relatively little variation in position. Therefore, it is difficult to sufficiently measure the attitude of the kite 1 only in IMU 14 where the inertial force generated by the movement of the moving object (here, the kite 1) is used. The calibration unit 113 of the control device 10 calibrates the attitude of the kite 1 measured by IMU 14 based on the imaginary horizontal axis estimated by the horizontal axis estimation unit 112. Therefore, according to the control device 10, the attitude of the kite 1 can be appropriately specified.

### Second Embodiment

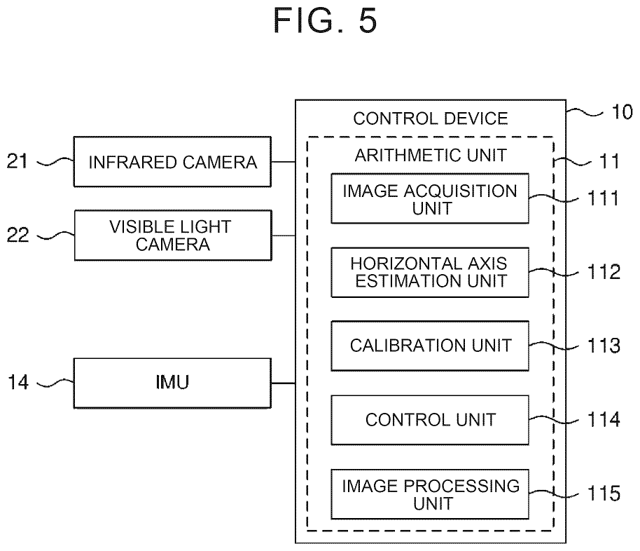

A second embodiment of the control device will be described with reference to FIG. 5 in addition to FIGS. 1, 2, and 4. Note that the second embodiment may be the same as the first embodiment described above except that part of the configuration of the arithmetic unit 11 is different. Therefore, the description of the second embodiment that overlaps with the description of the first embodiment will be omitted as appropriate.

In FIG. 5, the arithmetic unit 11 of the control device 10 includes an image acquisition unit 111, a horizontal axis estimation unit 112, a calibration unit 113, a control unit 114, and an image processing unit 115 as functional blocks that are logically realized or as processing circuits that are physically realized. Note that at least one of the image acquisition unit 111, the horizontal axis estimation unit 112, the calibration unit 113, the control unit 114, and the image processing unit 115 may be realized in a format in which a logical functional block and a physical processing circuit (that is, hardware) are mixed.

In addition to the infrared camera 21, a visible light camera 22 may be attached to the kite 1. The visible light camera 22 may be attached to the kite 1 so as to be able to capture an image of a range including at least part of the imaging range of the infrared camera 21. The visible light camera 22 may generate a visible light image by capturing at least part of the surroundings of the kite 1 (here, a range including at least part of an imaging range of the infrared camera 21).

The image acquisition unit 111 of the arithmetic unit 11 acquires an infrared image from the infrared camera 21 and acquires a visible light image from the visible light camera 22. The image processing unit 115 of the arithmetic unit 11 may detect an object (for example, a cloud, a mountain, a water surface, a structure, or the like) other than the atmosphere included in the visible light image. For example, an image analysis model using a neural network may be used to detect an object other than the atmosphere included in the visible light image.

In a case where an object other than the atmosphere is detected from the visible light image (in other words, in a case where an object other than the atmosphere is included in the visible light image), the image processing unit 115 masks a region corresponding to the object other than the atmosphere in the infrared image. The horizontal axis estimation unit 112 estimates the imaginary horizontal axis based on the atmospheric temperature distribution shown by the infrared image resulting from masking the region. At this time, the horizontal axis estimation unit 112 of the arithmetic unit 11 may estimate a degree of reliability of the estimated imaginary horizontal axis based on the masked region in the infrared image. For example, the horizontal axis estimation unit 112 may increase the degree of reliability as the number of masked regions in the infrared image decreases. In other words, the horizontal axis estimation unit 112 may lower the degree of reliability as the number of masked regions in the infrared image increases.

The calibration unit 113 of the arithmetic unit 11 may calibrate the attitude of the kite 1 measured by IMU 14 based on the imaginary horizontal axis estimated by the horizontal axis estimation unit 112. At this time, the calibration unit 113 may change the weight related to the calibration of the attitude of the kite 1 based on the degree of reliability estimated by the horizontal axis estimation unit 112. For example, when the degree of reliability is relatively high, the calibration unit 113 may make the weight related to the imaginary horizontal axis estimated by the horizontal axis estimation unit 112 larger than the weight related to the attitude of the kite 1 measured by IMU 14. For example, when the degree of reliability is relatively low, the calibration unit 113 may make the weight related to the imaginary horizontal axis estimated by the horizontal axis estimation unit 112 smaller than the weight related to the attitude of the kite 1 measured by IMU 14.

When the proportion of the region corresponding to the cloud in the visible light image is equal to or larger than the predetermined value, the control unit 114 of the arithmetic unit 11 may increase the altitude of the kite 1. In this case, the control unit 114 may control the equipment 2 so as to unwind the tether for mooring the kite 1.

### Technical Effect

When an imaginary horizontal axis is estimated based on the atmospheric temperature distribution, an object other than the atmosphere becomes noise. In the control device 10, since the image processing unit 115 masks a region corresponding to an object other than the atmosphere in the infrared image, the noise can be reduced. Therefore, according to the control device 10, the imaginary horizontal axis can be estimated more appropriately.

As described above, when the proportion of the region corresponding to the cloud in the visible light image is equal to or larger than the predetermined value, the control unit 114 of the arithmetic unit 11 may increase the altitude of the kite 1. In this case, the control unit 114 may increase the altitude of the kite 1 until the proportion of the region corresponding to the cloud in the visible light image is less than the predetermined value. For example, the control unit 114 may raise the altitude of the kite 1 until the kite 1 appears on the cloud. With this configuration, it is possible to relatively easily acquire an infrared image suitable for estimating an imaginary horizontal axis.

The “predetermined value” is a value for determining whether to increase the altitude of the kite 1. The “predetermined value” may be set as a fixed value in advance, or may be a variable value according to some physical quantity or parameter. The “predetermined value” may be set as follows, for example. The difference (i.e., error) between the imaginary horizontal axis based on the atmospheric temperature distribution shown by the infrared image and the actual horizontal axis may be determined for each proportion of the region corresponding to the cloud in the visible light image. The ratio of the region corresponding to the cloud in the visible light image, in which the difference becomes the upper limit value of the allowable range, may be set as a “predetermined value”.

Aspects of the disclosure derived from the above-described embodiments are described below.

A control device according to an aspect of the disclosure includes an acquisition unit that acquires an infrared image including at least part of surroundings of a moving object, and an estimation unit that estimates an imaginary horizontal axis based on an atmospheric temperature distribution of the atmosphere indicated by the infrared image. In the above-described embodiment, the “image acquisition unit 111” corresponds to an example of the “acquisition unit”, and the “horizontal axis estimation unit 112” corresponds to an example of the “estimation unit”.

In the control device, the acquisition unit may acquire a visible light image including the at least part. The control device may include a processing unit that masks a region corresponding to the object in the infrared image when the visible light image includes an object other than the atmosphere. In the control device, the estimation unit may estimate the imaginary horizontal axis based on an atmospheric temperature distribution shown by the infrared image resulting from masking the region. In the above-described embodiment, the “image processing unit 115” corresponds to an example of a “processing unit”.

In this aspect, the estimation unit may estimate the degree of reliability of the imaginary horizontal axis based on the masked region in the infrared image. In this aspect, the control device may include a control unit that increases an altitude of the moving object when a proportion of a region corresponding to a cloud in the visible light image is equal to or larger than a predetermined value.

The control device may include a measurement unit configured to measure an attitude of the moving object, and a calibration unit configured to calibrate the measured attitude based on the imaginary horizontal axis. In the above-described embodiment, the “IMU 14” corresponds to an example of the “measurement unit”, and the “calibration unit 113” corresponds to an example of the “calibration unit”.

The present disclosure is not limited to the above-described embodiments, and can be modified as appropriate within the scope and spirit of the disclosure that can be read from the claims and the entire specification, and a control device with such a modification is also included in the technical scope of the present disclosure.

What is claimed is:

1. A control device, characterized by comprising:
an acquisition unit that acquires an infrared image including at least part of surroundings of a moving object; and
an estimation unit that estimates an imaginary horizontal axis based on an atmospheric temperature distribution shown by the infrared image.

2. The control device according to claim 1, wherein:
the acquisition unit acquires a visible light image including the at least part,
the control device includes a processing unit that, when the visible light image includes an object other than an atmosphere, masks a region corresponding to the object in the infrared image; and
the estimation unit estimates the imaginary horizontal axis based on the atmospheric temperature distribution shown by the infrared image resulting from masking the region.

3. The control device according to claim 2, wherein the estimation unit estimates a degree of reliability of the imaginary horizontal axis based on the masked region in the infrared image.

4. The control device according to claim 2, further comprising a control unit that increases an altitude of the moving object when a proportion of a region corresponding to a cloud in the visible light image is equal to or larger than a predetermined value.

5. The control device according to claim 1, further comprising:
a measurement unit that measures an attitude of the moving object; and
a calibration unit that calibrates the measured attitude based on the imaginary horizontal axis.
